(19) United States
(12) Patent Application Publication
(10) Pub. No.: US 2013/0325813 A1
(43) Pub. Date: Dec. 5, 2013

(54) SYSTEM AND METHOD FOR ARCHIVE IN A DISTRIBUTED FILE SYSTEM

(71) Applicant: Joshua Daniel Carter, Lafayette, CO (US)

(72) Inventor: Joshua Daniel Carter, Lafayette, CO (US)

(73) Assignee: Spectra Logic Corporation, Boulder, CO (US)

(21) Appl. No.: 13/483,225

(22) Filed: May 30, 2012

(51) Int. Cl. G06F 17/30

(52) U.S. Cl. 707/661; 707/E17.01

(57) ABSTRACT

Provided is a system and method for archive in a distributed file system. The system includes at least one Name Node structured and arranged to map distributed data allocated to at least one Active Data Node, the Name Node further structured and arranged to direct manipulation of the distributed data by the Active Data Node. The system further includes at least one Archive Data Node coupled to at least one data read/write device and a plurality of portable data storage elements compatible with the data read/write device, the Archive Data Node structured and arranged to receive distributed data from at least one Active Data Node, archive the received distributed data to at least one portable data storage element and respond to the Name Node directions to manipulate the archived data. An associated method of use is also provided.

### CROSS-REFERENCE TO RELATED APPLICATIONS

None.

### FIELD OF THE INVENTION

The present invention relates generally to systems and methods for data storage, and more specifically to systems and methods for data storage in a distributed file system.

### BACKGROUND

Data processing systems area a staple of digital commerce, both private and commercial. Speed of data processing is important and has been addressed in a variety of different ways. In some instances, greater memory and central processing power are desirable—albeit at increased cost over system or systems with less memory and processing power.

In one popular configuration for data processing it has been realized that by increasing parallel processing, overall speed of processing also increases. Moreover, the data is subdivided and distributed to many different systems each of which works in parallel to process its received chunk of data and return a result.

Hadoop is presently one of the most popular methods to support the processing of large data sets in a distributed computing environment. Hadoop is an Apache open-source software project originally conceived on the basis of Google's MapReduce framework, in which an application is broken down into a number of small parts.

More specifically, Hadoop processes large quantities of data by distributing the data among a plurality of nodes in a cluster and then processes the data using an algorithm such as, for example, the MapReduce algorithm. The Hadoop Distributed File System, or HDFS, stores large files across multiple hosts, and achieves reliability by replicating the data also among the plurality of hosts.

In other words, a file received from a client or from other active applications is subdivided into a plural of blocks, typically established to be 64 MB each. These blocks are then replicated throughout the HDFS system, typically at a default value of 3—which is to say three copies of each block exist within the HDFS system.

Generally speaking, one or more Name Nodes are established to map the location of the data as distributed among a plurality of Data Nodes. For a default implementation, the data blocks are distributed to three Data Nodes, two on the same rack and one on a different rack. Such a distribution methodology attempts to insure that if a system, i.e. Data Nodes is taken down, or even if one rack is lost—at least one additional copy remains viable for use.

Within a general HDFS setting, the Name Node and Data Node are in general distinct processes which are provided on different physical or virtual systems. In addition, the JobTracker and TaskTracker are processes. In general, the same physical or virtual system that supports the Name Node also supports the JobTracker and the same physical or virtual system that supports the Data Node also supports the TaskTracker. As such, references to the Name Node are often understood to imply reference to Name Node as an application as well as the physical or virtual system providing support, as well as the JobTracker. Likewise, references to the Data Node are often understood to imply reference to the Data Node as an application as well as the physical or virtual system providing support as well as the TaskTracker.

In addition, HDFS is established with data awareness between the JobTracker (e.g., the Name Node) and the task tracker (e.g., Data Node), which is to say that the Name Node schedules tasks to Data Nodes with an awareness of the data location. More specifically if Data Node 1 has data blocks A, B and C and Data Node 2 has data blocks X, Y and Z the Name Node will task Data Node 1 with tasks relating to blocks A, B and C and task Data Node 2 with tasks relating to blocks X, Y and Z. Such tasking reduces the amount of network traffic and attempts to avoid unnecessary data transfer as between Data Nodes.

Moreover, shown in FIG. 1 is an exemplary prior art distributed file system 100, e.g., HDFS 100. A client 102 has a file 104 that is to be disposed within the distributed file system 100 as a plurality of blocks 106, of which blocks 106A, 106B and 106C are exemplary. As shown, the distributed file system 100 has a Name Node 108 and a plurality of Data Nodes 110 of which Data Nodes 110A-110H are exemplary. In addition Data Nodes 110A-110D are disposed in a first rack 112 coupled to the Ethernet 114 and Data Nodes 110E-110H are disposed in a second rack 116 that is also coupled to the Ethernet 114. Name Node 108 and the client 102 are likewise also connected to the Ethernet 116.

Within HDFS 100 the Data Nodes 110 can and do communicate with each other to rebalance data blocks 106. However, the data is maintained in an active state by each Data Node 110, ready to receive the next task regarding data block processing. Storage devices integral to each Data Node, such as a hard drive, may of course be put to sleep, but the ever present readiness and fundamental hard wiring for power and data interconnection imply that the node is still considered an active Data Node and fully powered.

Further, although one or more Data Nodes 110 may be backed up, such a back up is separate and apart from HDFS, not directly accessible by HDFS, not directly mountable by another file system, and may well be of little value as HDFS is designed to reallocate lost blocks which would likely occur at a faster rate then re-establishing a system from a backup. More specifically, whether backed up or not, only the data blocks within each Data Node 110 are the data blocks in use.

Because of the distributed nature and ability to task jobs to Data Nodes 110 already holding the relevant data blocks, HDFS 100 permits a variety of different types of physical systems to be employed in providing the Data Nodes 110. To increase processing power and capability, generally more Data Nodes 110 are simply added. When a Data Node 110 reaches storage capacity, either more active storage must be provided to that Data Node 110, or further data blocks must be allocated to a different Data Node 110.

HDFS 100 does permit data to be migrated in and out of the HDFS 100 environment, but of course data that has been removed, i.e., exported, is not recognized by HDFS 100 as available for task processing. Likewise, the use of data blocks 106 that are distributed in a dispersed fashion prevents HDFS 100, and more specifically a selected Data Node 110 from being directly mounted by an existing operating system. In the event of a catastrophic disaster or critical need to obtain file information directly from a Data Node 110, this lack of direct access may be a significant issue.

Moreover, the high scalability and flexibility for distributing processing of data is achieved at the cost of maintaining redundancy of block copies as well as maintaining the ready state of many Data Nodes. When and as the frequency of use and for some data blocks diminishes, these costs may become more noteworthy.

It is to innovations related to this subject matter that the claimed invention is generally directed.

### SUMMARY

Embodiments of this invention provide a system and method for data storage, and more specifically to systems and methods for archive in a distributed file system.

In particular, and by way of example only, according to one embodiment of the present invention, provided is an archive system for a distributed file system, including: at least one Name Node structured and arranged to map distributed data allocated to at least one Active Data Node, the Name Node further structured and arranged to direct manipulation of the distributed data by the Active Data Node; at least one Archive Data Node coupled to at least one data read/write device and a plurality of portable data storage elements compatible with the data read/write device, the Archive Data Node structured and arranged to receive distributed data from at least one Active Data Node, archive the received distributed data to at least one portable data storage element and respond to the Name Node directions to manipulate the archived data.

In another embodiment, provided is an archive system for a distributed file system, including: a distributed file system having at least one Name Node and a plurality of Active Data Nodes, a first data element disposed in the distributed file system as a plurality of data blocks distributed among a plurality of Active Data Nodes and mapped by the Name Node; and at least one Archive Data Node having a data read/write device and a plurality of portable data storage elements compatible with the data read/write device, the Archive Data Node structured and arranged to receive the first data element data blocks from the Active Data Nodes and archive the received data blocks upon at least one portable data storage element.

In yet another embodiment, provided is an archive system for a distributed file system, including: means for providing at least one Archive Data Node having a data read/write device and a plurality of portable data storage elements compatible with the data read/write device; means for permitting a user of the distributed file system to identify a given file for archiving, the given file subdivided as a set of data blocks distributed to a plurality of Active Data Nodes; means for moving the set of data blocks of the given file to the Archive Data Node; means for archiving the given file to at least one portable data storage element with the read/write device; and means for updating a map record of at least one Name Node to identify the Archive Data Node as the repository of the given file.

Further, provided for another embodiment is a method for archiving data in a distributed file system including: providing at least one Archive Data Node having a data read/write device and a plurality of portable data storage elements compatible with the data read/write device; permitting a user of the distributed file system to identify a given file for archiving, the given file subdivided as a set of data blocks distributed to a plurality of Active Data Nodes; moving the set of data blocks of the given file to the Archive Data Node; archiving the set of data blocks of the given file to at least one portable data storage element with the read/write device as the given file; and updating a map record of at least one Name Node to identify the Archive Data Node as the repository of the set of data blocks of the given file.

For yet another embodiment, provided is a method for archiving data in a distributed file system including: establishing in a name space of a distributed file system and at least one archive path; reviewing the archive path to identify data blocks intended for archive, the intended data blocks distributed to at least one Active Data Node; migrating the data blocks from at least one Active Data Node to an Archive Data Node, the Archive Data Node having a data read/write device and a plurality of portable data storage elements compatible with the data read/write device; archiving the migrated data to at least one portable data storage element with the read/write device; and updating a map record of at least one Name Node to identify the Archive Data Node as the repository of the subset of data blocks.

Still further, provided for another embodiment is a method for archiving data in a distributed file system including: identifying data blocks distributed to a plurality of Active Data Nodes, each data block having at least one adjustable attribute; reviewing the attributes to determine at least a subset of data blocks for archive; migrating the subset of data blocks from at least one Active Data Node to an Archive Data Node, the Archive Data Node having a data read/write device and a plurality of portable data storage elements compatible with the data read/write device; writing the migrated data blocks to at least one portable data storage element; and updating a map record of at least one Name Node to identify the Archive Data Node as the repository of the subset of data blocks.

Further still, in another embodiment is an archive system for a distributed file system, including: a distributed file system having at least one Name Node and a plurality of Active Data Nodes, a first data element disposed in the distributed file system as a plurality of data blocks, each data block having N copies, each copy on a distinct Active Data Node and mapped by the Name Node; a Archive Data Node having a data read/write device and a plurality of portable data storage elements compatible with the data read/write device, the Archive Data Node structured and arranged to receive the first data element data blocks from the Active Data Nodes and archive the received data blocks upon at least one portable data storage element, the number of archive copies for each data block being a positive number B.

Still in another embodiment, provided is an archive system for a distributed file system, including: means for identifying a distributed file system having at least one Name Node and a plurality of Active Data Nodes; means for identifying at least one file subdivided as a set of blocks disposed in the distributed file system, each block having N copies, each copy on a distinct Active Data Node; means for providing at least one Archive Data Node having a plurality of portable data storage elements; means for coalescing at least one set of N copies of the data blocks from the Active Data Nodes upon at least one portable data storage element of the Archive Data Node as files to provide B copies; and means for mapping the B copies to maintain an appearance of N total copies within the distributed file system.

Still further, in another embodiment, provided is a method for archiving data in a distributed file system, including: identifying a distributed file system having at least one Name Node and a plurality of Active Data Nodes; identifying at least one file subdivided as a set of blocks disposed in the distributed file system, each block having N copies, each copy on a distinct Active Data Node; providing at least one Archive Data Node having a plurality of portable data storage elements; coalescing at least one set of N copies of the data blocks from the Active Data Nodes upon at least one portable data storage element of the Archive Data Node as files to provide B copies, wherein B is at least N−1; and mapping the B copies to maintain an appearance of N total copies within the distributed file system.

And still further, for yet another embodiment, provided is a method for archiving data in a distributed file system, including: identifying a distributed file system having at least one Name Node and a plurality of Active Data Nodes; providing at least one Archive Data Node having a data read/write device and a plurality of portable data storage elements compatible with the data read/write device; permitting a user of the distributed file system to identify a given file for archiving, the given file subdivided as a set of data blocks disposed in the distributed file system, each data block having N copies, each copy on a distinct Active Data Node; migrating a first set of blocks of the given file from an Active Data Node to the Archive Data Node; archiving the first set of blocks to at least one portable data storage element with the read/write device to provide at least B number of Archive copies; deleting at least the first set of blocks from the Active Data Node; and updating a map record of at least one Name Node to identify the Archive Data Node as the repository of at least one copy of the given file.

In another embodiment, provided is an archive system for a distributed file system, including: at least one Name Node structured and arranged to map distributed data allocated to at least one Active Data Node, the Name Node further structured and arranged to direct manipulation of the data by the Active Data Node; at least one Archive Data Node coupled to a data read/write device and a plurality of non-powered portable data storage elements compatible with the data read/write device, the Archive Data Node structured and arranged to receive data from at least one Active Data Node, archive the received data to at least one non-powered portable data storage element and respond to the Name Node directions to manipulate the archived data, the archived received data maintained in a non-powered state.

In yet another embodiment, provided is an archive system for a distributed file system, including: a distributed file system having at least one Name Node and a plurality of Active Data Nodes, a first data element disposed in the distributed file system as a plurality of data blocks distributed among a plurality of Active Data Nodes and mapped by the Name Node; and a Archive Data Node having a data read/write device and a plurality of portable data storage elements compatible with the data read/write device, the Archive Data Node structured and arranged to receive the first data element data blocks from the Active Data Nodes and archive the received data blocks upon at least one non-powered portable data storage element as at least one file, the archived file maintained in a non-powered state.

For yet another embodiment provided is an archive system for a distributed file system, including: means for providing at least one Archive Data Node having a data read/write device and a plurality of non-powered portable data storage elements compatible with the data read/write device; means for permitting a user of the distributed file system to identify a given file for archiving, the given file subdivided as a set of data blocks distributed to a plurality of Active Data Nodes maintaining the data blocks in a powered state; means for moving the set of data blocks of the given file from the powered state of the Active Data Nodes to the Archive Data Node; means for archiving the set of data blocks of the given file to at least one non-powered portable data storage element with the read/write device, the archive maintained in a non-powered state; and means for updating a map record of at least one Name Node to identify the Archive Data Node as the repository of the set of data blocks of the given file.

And still further, in yet another embodiment, provided is a method for archiving data in a distributed file system including: providing at least one Archive Data Node having a data read/write device and a plurality of non-powered portable data storage elements compatible with the data read/write device; permitting a user of the distributed file system to identify a given file for archiving, the given file subdivided as a set of data blocks distributed to a plurality of Active Data Nodes maintaining the data blocks in a powered state; moving the set of data blocks of the given file from the powered state of the Active Data Nodes to the Archive Data Node; archiving the set of data blocks of the given file to at least one non-powered portable data storage element with the read/write device, the archive maintained in a non-powered state; and updating a map record of at least one Name Node to identify the Archive Data Node as the repository of the set of data blocks of the given file.

### BRIEF DESCRIPTION OF THE DRAWINGS

At least one system and method for a storage system response with migration of data will be described, by way of example in the detailed description below with particular reference to the accompanying drawings in which like numerals refer to like elements, and:

FIG. 1 illustrates a conceptual view of a prior art system for a distributed file system without archive;

FIG. 2 is a conceptual view of an archive system for a distributed file system in accordance with certain embodiments of the present invention;

FIG. 3 is a high level flow diagram of a method for archiving data in a distributed file system in accordance with certain embodiments of the present invention;

FIGS. 4-6 are a conceptual views of an archive system for a distributed file system performing an archive of a given file in accordance with certain embodiments of the present invention;

FIG. 7 is a high level flow diagram of yet another method for archiving data in a distributed file system in accordance with certain embodiments of the present invention;

FIG. 8 is a conceptual view of an archive system for a distributed file system responding to a request to manipulate data in accordance with certain embodiments of the present invention;

FIG. 9 is a generalized data flow diagram of an archive system for a distributed file system regarding the process of archiving data blocks for a given file in accordance with certain embodiments of the present invention;

FIG. 10 is a generalized data flow diagram of an archive system for a distributed file system regarding the process of responding to a request to manipulate data blocks for a given file in accordance with certain embodiments of the present invention; and

FIG. 11 is a block diagram of a generalized computer system in accordance with certain embodiments of the present invention.

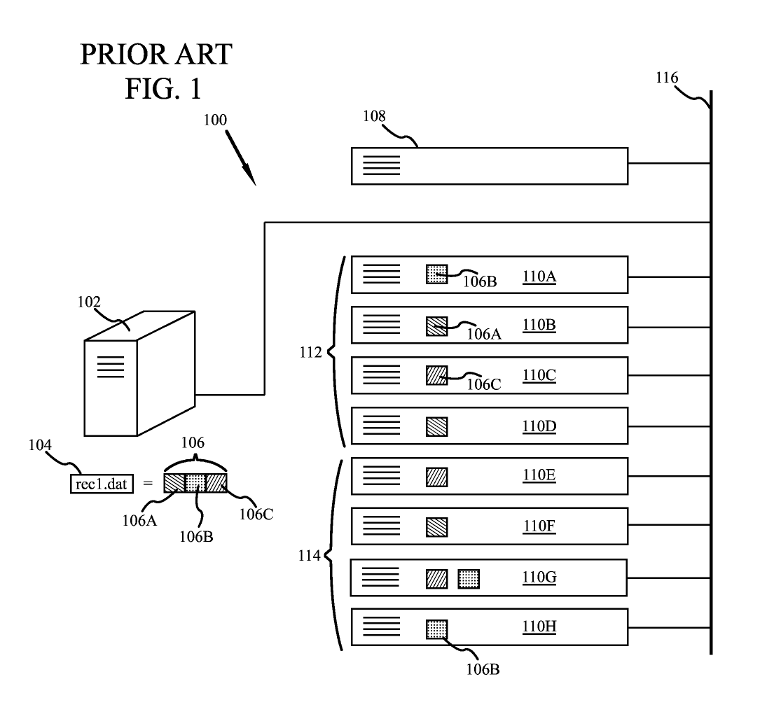

### DETAILED DESCRIPTION

Before proceeding with the detailed description, it is to be appreciated that the present teaching is by way of example only, not by limitation. The concepts herein are not limited to use or application with a specific of system or method for archiving data in a distributed file system. Thus, although the instrumentalities described herein are for the convenience of explanation shown and described with respect to exemplary embodiments, it will be understood and appreciated that the principles herein may be applied equally in other types of systems and methods for archive in a distributed file system.

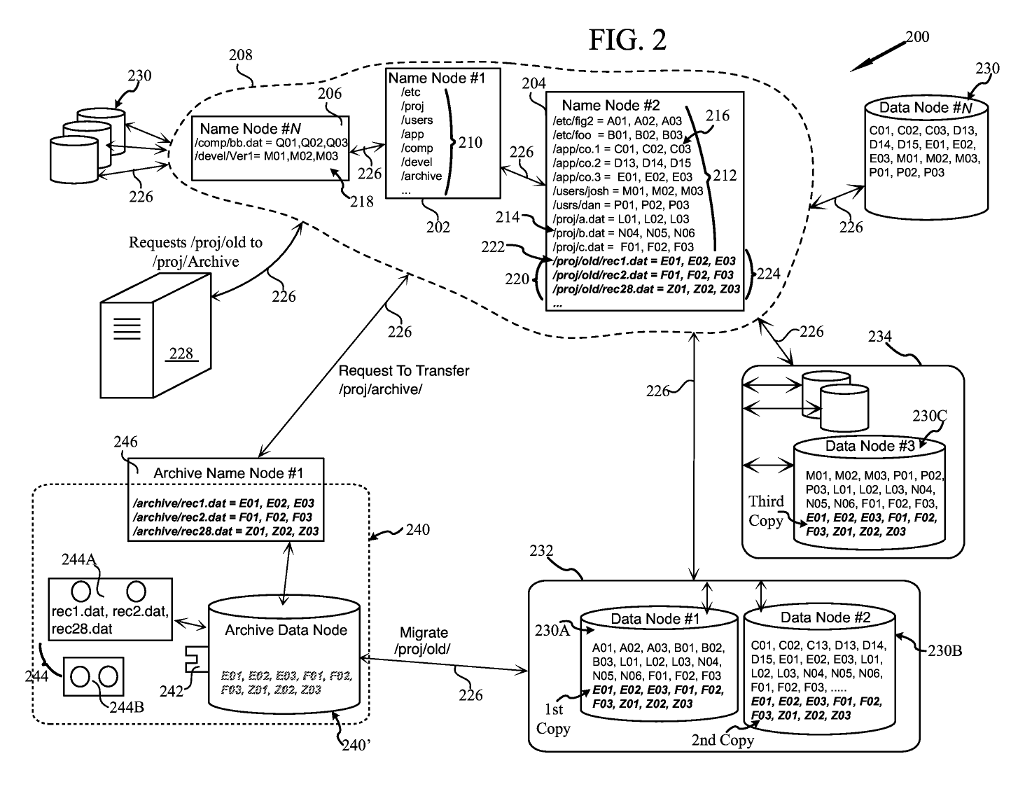

Turning now to the drawings, and more specifically FIG. 2, illustrated is a high level diagram of an archive system for a distributed file system (“ASDFS”) 200 in accordance with certain embodiments. As shown, ASDFS 200 generally comprises at least one Name Node 202, a plurality of Active Data Nodes 230, and at least one Archive Data Node 240.

It is understood and appreciated that although generally depicted as single elements, each Name Node 202, Active Data Node 230, and Archive Data Node 240 may indeed be a set of physical components interconnected. Each of these systems has a set of physical infrastructure resources, such as, but not limited, to one or more processors, main memory, storage memory, network interface devices, long term storage, network access, etc. . . .

In addition, it should be understood and appreciated that as used herein, references to Name Node 202, Active Data Node 230, Archive Data Node 240 and Archive Name Node 246 imply reference to a variety of different elements such as the executing application, the physical or virtual system supporting the application as well as the JobTracker or TaskTracker application, and such other applications as are generally related.

The Name Node 202 is structured and arranged to map distributed data allocated to at least one Active Data Node 230. More specifically, for at least one embodiment there are as shown a plurality of Name Nodes, of which Name Nodes 202, 204 and 206 are exemplary. These Name Nodes 202, 204 and 206 cooperatively interact as a Name Node Federation 208. As the Name Nodes 202, 204 and 206 support the name space, the ability to cooperatively interact as a Name Node Federation permits dynamic horizontal scalability for managing the map 210, 212 and 218 of directories, files and their correlating blocks as ASDFS 200 acquires greater volumes of data. As used herein, a single Name Node 202 may be understood and appreciated to be a representation of the Name Node Federation 208.

As shown, for at least one embodiment the first Name Node 202 has a general map 210 of an exemplary name space, such as an exemplary file structure having a plurality of paths aiding in the organization of data elements otherwise known as files. Second Name Node 204 has a more detailed map 212 relating the files 214 under its responsibility to the data blocks 216 comprising each file. Third Name Node 206, likewise, also has a more detailed map 218 relating the files 214 under its responsibility to the data blocks 216 comprising each file. Name Nodes 202, 204 and 206 may be independent and structured and arranged to operate without coordination with each other.

For ease of illustration and discussion, of the many exemplary files 214 three (3) files have been shown in bold italics as intended archive files 220, /proj/old/rec1.dat, /proj/old/rec2.dat and /proj/old/rec28.dat. In the discussion following below, these intended archive files 220, and more specifically first data element 222 identified as rec1.dat will aid in illustrating the structure and operation of ASDFS 200 with respect to the intended archive files 220 being disposed in ASDFS 200 as a plurality of data blocks 216 among a plurality of Active Data Nodes 230.

More specifically, for the intended archive files 220, their data blocks 224, specifically E01, E02, E03, F01, F02, F03 Z01, Z02 and Z03 which represent the files /proj/old/rec1.dat, /proj/old/rec2.dat and /proj/old/rec28.dat are shown to be distributed to Active Data Nodes 230A, 230B and 230C. As shown, it is also appreciated that Active Data Nodes 230A and 230B are physically located in the same first rack 232 and Active Data Node 230C is physically located in a second rack 234. Additional Active Data Nodes 230 are also illustrated to suggest the scalability.

Further, with respect to FIG. 2 it is appreciated the data blocks 216 as disposed upon the Active Data Nodes 230A, 230B and 230C are generally meaningless without reference to the Map 210, and specifically the detailed map 212 relating the data blocks 216 to actual files.

The Name Nodes 202, 204 and 206 and Active Data Nodes 230 are coupled together by network interconnections 226. Of course it is understood and appreciated that the network interconnections 226 may be physical wires, optical fibers, wireless networks and combinations thereof. Network interconnections 226 further permit at least one client 228 to utilize ASDFS 200. By way of the network interconnections 226, each Active Data Node 230 communicates with the Name Nodes 202, 204 and 206 and the Active Data Nodes 230 may be viewed as grouped together in one or more clusters.

The Active Data Nodes 230 send periodic reports to the Name Nodes 202, 204 and 206 and process commands from the Name Nodes 202, 204 and 206 to manipulate data. As used herein, the term “manipulate data” is understood and appreciated to include the migration or copying of data from one node to another as well as processing tasks, such as may be schedules by a JobTracker supported by the same physical or virtual system supporting the Name Node 202.

Moreover, for at least one embodiment the arrangement of Name Nodes 202, 204 and 206 in connection with the Active Data Nodes 230 is manifested as a Hadoop system, e.g, HDFS, or a derivative of a Hadoop inspired system, i.e., a program that stems from Hadoop but which may evolve to no longer be called Hadoop—collectively a Hadoop style ASDFS 200. Indeed the Active Data Nodes 230 are substantially the same as traditional Data Nodes, and or may be traditional Data Nodes as used in a traditional HDFS environment. For ease of discussion, these Active Data Nodes 230 have been further identified with the term “Active” to help convey understanding of their powered nature with respect to the storage and manipulation of assigned data blocks 216.

Further, for at least one embodiment, the client 228 is understood to be an application or a user, either of which is structured and arranged to provide data and or requests for processing of the data warehoused by ASDFS 200. Moreover, client 228 may be operated by a human user, a generally autonomous application such as a maintenance application, or another application that requests the manipulation files 214 (represented as data blocks 216) as a result of the manipulation of other data blocks 216.

At least one Archive Data Node 240 is also shown in FIG. 2. In contrast to the traditional Active Data Nodes 230, the Archive Data Node 240 is coupled to at least one read/write device 242 and a plurality of data storage elements 244, of which elements 244A and 244B are exemplary. For at least one embodiment, these data storage elements 244 are portable data storage elements 244. The portable data storage elements 244 are compatible with the read/write device 242.

Moreover, as is further discussed below, the Archive Data Node 240 may be a substantially unitary device, or the compilation of various distinct devices, systems or appliances which are cooperatively structured and arranged to function collectively as at least one Archive Data Node 240. As such, the Archive Data Node 240 is generally defined in FIG. 2 as the components within the dotted line 240.

Indeed, for at least one embodiment the component perceived as the Archive Data Node 240′ is a physical system adapted to perform generally as a Data Node as viewed by the Active Data Nodes 230 and the Name Nodes 202. For at least one embodiment, this Archive Data Node 240′ is further structured and arranged to map the archive data blocks 220 and to the portable data storage elements 244 upon which they are disposed. In at least one alternative embodiment, the Archive Data Node 240 is a virtual system provided by the physical system that is at least in part controlling the operation of the archive library providing the plurality of portable data storage elements 244.

It is understood and appreciated that portable data storage elements 244 may comprise, a tape, a tape cartridge, an optical disc, a magnetic encoded disc, a disk drive a memory stick, memory card, a solid state drive, or any other tangible data storage device suitable for archival storage of data within, such as but not limited to a tape, optical disc, hard disk drive, non-volatile memory drive or other long term storage media.

In addition, to advantageously increase storage capacity, for certain embodiments, the portable data storage elements 244 are arranged in portable containers, not shown. These portable containers may comprise tape packs, tape drive packs, disk packs, disk drive packs, solid state drive packs or other structures suitable for temporarily storing subsets of the portable data storage elements 244.

It is understood and appreciated that read/write device 242, as used herein, is considered to be a device that forms a cooperating relationship with a portable data storage element 244, such that data can be written to and received from the portable data storage element 244 as the portable data storage element 244 serves as a mass storage device. Moreover, in at least one embodiment a read/write device 242 as set forth herein is not merely a socket device and a cable, but a tape drive that is adapted to receive tape cartridges, a disk drive docking station which receives a disk drive adapted for mobility, a disk drive magazine docking station, a compact Disc (CD) drive used with a CD, a Digital Versatile Disc (DVD) drive for use with a DVD, a compact memory receiving socket, mobile solid state devices, etc. . . . In addition, although a single read/write device 242 is shown, it is understood and appreciated that multiple read/write devices 242 may be provided.

It is further understood and appreciated that in varying embodiments the portable data storage elements 244 are structured and arranged to provide passive data storage. Passive data storage as used herein is understood and appreciated to encompass the storage of data in a form that requires, in general, no direct contribution of power beyond that used for the initial read/write operation until a subtenant read/write operation is desired. In other words, following the application of a magnetic field to align a bit, the flow of current to define a path, the application of a laser to change a surface or other operation that may be employed to record a data value, continued or even periodic refreshing of the field, current, light or other operation is not required to maintain the record of the data value.

Indeed, for at least one exemplary embodiment such as a tape library, it is understood and appreciated that the portable data storage elements 244 are non-powered portable data storage elements 244. Moreover, as used herein, the term non-powered portable data storage element is understood and appreciated to refer to the state of the portable data storage element during a time of storage or general non-use in which the portable data storage element is disposed within a storage system, such as upon a shelf, and is effectively removed from a power source that is removably attached when the transfer of data to or from the portable data storage element is desired.

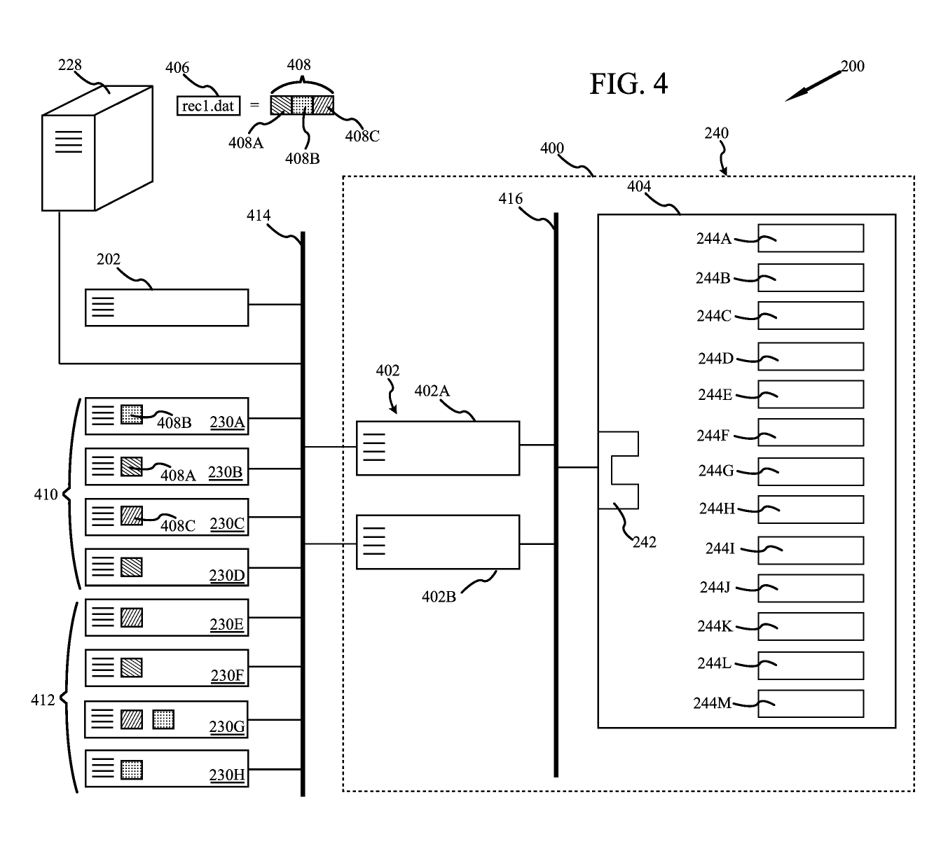

As is generally suggested in FIG. 2 and further described in connection with the accompanying FIGS. 4-7, a request from the client 228 to move “/proj/old/” to “/proj/archive” results in the migration of the data blocks 224, specifically E01, E02, E03, F01, F02, F03 Z01, Z02 and Z03 representing files /proj/old/rec1.dat, /proj/old/rec2.dat and /proj/old/rec28.dat from at least one Active Data Node 230A, 230B or 230C to the Archive Data Node 240. It is to be understood and appreciated that for at least one embodiment, at first a metadata update will occur regarding the mapping for responsibility of the data blocks 216. In the case of federated Name Nodes including an Archive Name Node, the reassignment of metadata from a Name Node 202 to the Archive Name Node 246 will occur first, and the Archive Name Node 246 will then direct the actual data block 216 migration.

For at least one embodiment this migration of data is performed with a traditional Hadoop file system “move” or “copy” command, such as but not limited to “mv” or “cp”. Use of traditional Hadoop file system move or copy commands advantageously permits embodiments of ASDFS 200 to be established with existing HDFS environments and to use existing commands for the migration of data from an Active Data Node 230 to an Archive Data Node 240. It is also understood and appreciated that in most instances a move command such as “mv” is implemented by first creating a copy at the intended location and then deleting the original version. This creates the perception that a move has occurred, although the original data bit itself has not been physically moved.

With the data blocks 224 received, specifically E01, E02, E03, F01, F02, F03 Z01, Z02 and Z03, the Archive Data Node 240 archives the received data upon portable data storage element 244A. As shown, it is also understood and appreciated, that the data blocks 224, specifically E01, E02, E03, F01, F02, F03 Z01, Z02 and Z03 are coalesced as traditional files such that the archived copies are directly mountable by an existing file system.

Upon completion of the archiving to the portable data storage element 244A the data blocks 224, specifically E01, E02, E03, F01, F02, F03 Z01, Z02 and Z03 are expunged from the cache memory of the Archive Data Node 240′. As such, data blocks 224, specifically E01, E02, E03, F01, F02, F03 Z01, Z02 and Z03 are shown in fuzzy font on Archive Data Node 240′ to further illustrate their non-resident, transitory nature with respect to the active and powered components of Archive Data Node 240. However, unlike a traditional backup of an Active Name Node 230, with respect to ASDFS 200 it is to be understood and appreciated that it is the set of data blocks 224, specifically E01, E02, E03, F01, F02, F03 Z01, Z02 and Z03 as held by the portable data storage element 244A which are available for use and manipulation upon request by a client 228.

It is to be understood and appreciated that upon a directive to manipulate the archived data, the Archive Data Node 240 is structured and arranged to identify the requisite portable data storage element 244 and load the relevant data elements into active memory for processing. The inherent latency of the physical archive storage arrangement for the portable data storage elements 244 may introduce a potential element of delay for response in comparison to some Active Data Nodes 230, but it is understood and appreciated that from the perspective of a requesting user or application the functional operation of the Archive Data Node 240 is transparent and perceived as substantially equivalent to an Active Data Node 230.

Additionally, for at least one embodiment, an Archive Name Node 246 is disposed between the original Name Nodes 204, 206 and 208 and the Archive Data Node 240. This Archive Name Node 246 is structured and arranged to receive from at least on Name Node, i.e. Name Node 202, a portion of the map 210 of distributed data allocated to the at least one Archive Name Node 246, e.g., the “/archive” path.

In varying embodiments, the Archive Name Node 246 may be disposed as part of the Name Node Federation 208. Indeed the Archive Name Node 246 is structured and arranged to maintain appropriate mapping of a given file archived by Archive Name Node 240, but may also maintain the appropriate mapping of the data blocks 216 for that given file as still maintained by one or more Active Name Nodes 220. Moreover, during the migration of the data blocks 216 from an Active Name Node 220 to the Archive Data Node 240, in varying embodiments the Archive Name Node 246 map may well include reference mapping for not only the Archive Data Node 240 as the destination but also the origin Active Data Node 230.

In addition, as noted above, in a traditional HDFS environment, the data blocks 216 representing the data element (i.e., the file) are replicated a number of N times—such as the exemplary 3 times shown in FIG. 2 for the data blocks 224, specifically E01, E02, E03, F01, F02, F03 Z01, Z02 and Z03 shown disposed on Active Data Nodes 230A, 230B and 230C.

With respect to the Active Data Nodes 230, such replication is desired to provide a level of safeguard should one or more Active Data Nodes 230 fail. However, the data storage integrity of the portable data storage elements 244 is appreciated to be greater than that of a general system. As the portable data storage elements are for at least one embodiment disconnected from the read/write device 242 when not in use, the portable data storage elements 244 are further sheltered from power spikes or surges and will remain persistent as passive data storage elements even if the mechanical and electrical components comprising the rest of the Archive Data Node 240 are damaged, replaced, upgraded, or otherwise changed.

In light of the potentially increased level of data integrity provided by the Archive Data Node 240, for at least one embodiment, it is understood and appreciated that the total number of actual copies N of a data element within the ASDFS 200 may be reduced. Moreover, for at least one embodiment the Archive Name Node 246 is further structured and arranged to provide virtual mapping of the file blocks 216 so as to report the N number of copies expected while in actuality maintaining a lesser number B. Indeed, certain embodiments contemplate creation of additional archive copies that are removed to offsite storage for greater security, such that the number of number of archived copies B may actually be greater than N.

Even where the number of actual copies N of the data element is maintained, it is understood and appreciated that the removal of even one instance of a copy from Active Data Node 230A permits the ASDFS 200 to assume more data elements as space has been reclaimed on the original Active Data Node 230A. Migration of all copies from Active Data Nodes 230A, 230B and 230C to the Archive Data Node 240 further increases the available active resources of ASDFS 200 without requiring the addition of new active hardware, such as a new Active Data Node 230.

As noted, for at least one embodiment the Archive Name Node 246 may provide virtual mapping to relate B number of Archive copies to N number of expected copies. In varying embodiments, the Archive Data Node 240 may also map B number of Archive Copies to N number of expected copies. Further, in yet other embodiments virtualized instances of Archive Data Node 240 may be provided each mapping to the same B number of archive copies such that from the perspective of the Archive Name Node 246 or even the normal Name Node 202 or Name Node Federation 208 the expected N number of copies are present.

Of course it should also be understood and appreciated that additional archive copies may be created that are subsequently removed for disaster recovery purposes. These archive copies may be identical to the original archive copies and may be created at the same time as the original archiving process or at a later date. As these additional copies are removed from ASDFS 200, for at least one embodiment, they are not included in the mapping manipulation that may be employed to relate B archive copies to N expected copies.

Moreover, with respect to the above description and depiction provided in FIG. 2, it is understood and appreciated that varying embodiments of ASDFS 200 may be advantageously characterized in at least three forms, each of which may be implemented distinctly or in varying combinations. A first is an active user driven system, i.e., the user as either a person or application is responsible for directing an action for archiving. A second is where the archive is a passive, non-powered archive. A third is where the archive permits manipulation of the actual number of redundant copies present in ASDFS 200.

To summarize, for at least one embodiment, provided is ASDFS 200 having at least one Name Node 202 structured and arranged to map distributed data allocated to at least one Active Data Node 230. The Name Node 202 is also structured and arranged to direct manipulation of the distributed data by the Active Data Node 230. In addition, provided as well is at least one Archive Data Node 240 coupled to at least one data read/write device 242 and a plurality of portable data storage elements 244 compatible with the data read/write device 242. The Archive Data Node 240 is structured and arranged to receive distributed data from at least one Active Data Node 230 and archive the received distributed data to at least one portable data storage element 244. The Archive Data Node 230 is also structured and arranged to respond to the Name Node 202 directions to manipulate the archived data.

For yet at least one other embodiment, provided is ASDFS 200 having at least one Name Node 202 structured and arranged to map distributed data allocated to at least one Active Data Node 230. The Name Node 202 is also structured and arranged to direct manipulation of the distributed data by the Active Data Node 230. In addition, provided as well is at least one Archive Data Node 240 coupled to at least one data read/write device 242 and a plurality of non-powered portable data storage elements 244 compatible with the data read/write device 242. The Archive Data Node 240 is structured and arranged to receive distributed data from at least one Active Data Node 230 and archive the received distributed data to at least one non-powered portable data storage elements 244. The Archive Data Node 230 is also structured and arranged to respond to the Name Node 202 directions to manipulate the archived data, the archived received data maintained in a non-powered state.

For at least one alternative embodiment, provided is ASDFS 200 having a distributed file system having at least one Name Node 202 and a plurality of Active Data Nodes 230. A first data element, such as a data file 214, is disposed in the distributed file system as a plurality of data blocks 216, each data block 216 having N copies, each copy on a distinct Active Data Node 230 and mapped by the Name Node 202. Additionally, provided as well is at least one Archive Data Node 240 having a data read/write device 242 and a plurality of portable data storage elements 244 compatible with the data read/write device 242. The Archive Data Node 240 is structured and arranged to receive the first data element data blocks 216 from the Active Data Nodes 230 and archive the received data blocks upon at least one portable data storage element 244, the number of archive copies for each data block being a positive number B. In varying embodiments, B is at least one less than N, equal to N or greater than N.

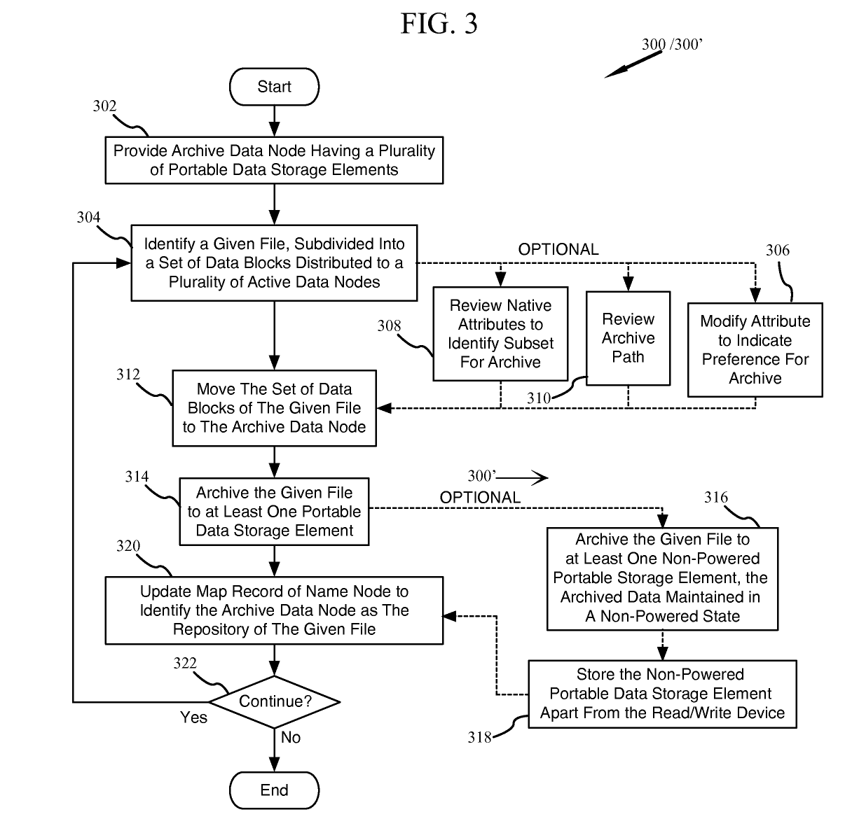

FIGS. 3 through 6 conceptually illustrate at least one method 300 for how ASDFS 200 advantageously provides the archiving of data in a distributed file system. It will be understood and appreciated that the described method need not be performed in the order in which it is herein described, but that this description is merely exemplary of one method for archiving under ASDFS 200.

FIGS. 4-6 and 8 provide an alternative view of ASDFS 200 that have been simplified with respect to the number of illustrated components for ease of discussion and illustration with respect to describing optional methods for archiving data in a distributed file system.

Turning now to FIGS. 3 and 4, at a high level, method 300 may be summarized and understood as follows. For the illustrated example, method 300 commences by providing at least one Archive Data Node 230, having a plurality of data storage elements 244, block 302.

As shown in FIG. 4, in varying embodiments, the Archive Data Node 230 may be generalized as an appliance providing both the data node interaction characteristics and the archive functionality as indicated by the dotted line 400, or the Archive Data Node 230 may be the compilation of at least two systems, the first being an Archive Data Node system 402, of which Archive Data Node system 402A is exemplary, that is structured and arranged to operate with the appearance to the distributed file system as a typical Data Node. This Archive Data Node system 402A is coupled to an archive library 404 by a data interconnection 416, such as, but not limited to, Serial Attached SCSI, Fiber Channel, or Ethernet. In the archive library 404 are disposed a plurality of portable data storage elements 244, such as exemplary portable data storage elements 244A-244M.

As shown, for at least one embodiment, multiple Archive Data Node systems 402A, 402B may be provided which share an archive library 404 as shown. For an alternative embodiment, not shown, each Archive Data Node system 402A, 402B is communicatively connected to its own distinct archive library. It is also understood and appreciated that either the Archive Data Node system 402 or the archive library 440 itself are structured and arranged to provide direction for traditional system maintenance of the portable data storage elements 244, such as but not limited to, initializing, formatting, changer control, data management and migration, etc. . . .

As is also shown in FIG. 4, client 228 has provided a first data element 406, such as exemplary file “rec1.dat”. First data element 406 has been subdivided as a plurality of data blocks 408, of which data blocks 408A, 408B and 408C are exemplary. These data blocks 408 have been distributed among the plurality of Active Data Nodes 230A-230H as disposed in a first rack 410 and a second rack 412, each coupled to Ethernet 414.

It is of course understood and appreciated that in varying embodiments, a first data element 406 may be represented as a single data block 408, two data blocks 408, or a plurality of data blocks in excess of the exemplary three data blocks 408A, 408B and 408C, as shown. Indeed, the use of three exemplary data blocks 408 is for ease of illustration and discussion and is not suggested as a limitation. In addition, although the size of each data block 408 is generally assumed to be the same, in varying embodiments, ASDFS 200 may be configured to permit data blocks 408 of varying sizes.

The method 300 continues by identifying a given file for archiving, e.g., first data element 406 that has been subdivided into a set of data blocks 408A, 408B and 408C and distributed to a plurality of Active Data Nodes 230A-230H, block 304.

With respect to the aspect of identifying a given file for archive, varying embodiments may be adapted to implement the process of identification in different ways. For example, in at least one embodiment, each data block is understood and appreciated to have at least one attribute. For at least one embodiment, this attribute is a native attribute such as the date of last use, i.e., the date of last access for read or write, that is understood and appreciated to be natively available in a traditional distributed file system. In at least one alternative embodiment, this attribute is an enhanced attribute that is provided as an enhanced user feature for users of ASDFS 200, such as additional metadata regarding the author of the data, the priority of the data, or other aspects of the data.

For at least one embodiment, the attributes of each data block are reviewed to determine at least a subset of data blocks for Archive. For example, in a first instance data blocks having an attribute indicating a date of last use more than 6 months back from the current date are identified as appropriate for archive. In a second instance, data blocks having an attribute indicating that they are associated with a user having very low priority are identified as appropriate for archive.

For at least one other alternative embodiment, identifying a given file for archive can also be achieved by use of the existing name space present in ASDFS 200. For example, in at least one embodiment, the name space includes at least one archive path, e.g., “/archive.”

Data elements that are placed in the archive path are understood and appreciated to be appropriate for archiving. The archiving process can be implemented at regular time intervals, such as an element of system maintenance, or at the specific request of a client 228. It should also be understood and appreciated that an attribute of each data block may also be utilized for identifying a given file for migration to the archive path. Moreover, for data blocks having a date of last use older than a specified date may be identified by at least one automated process and moved to the archive path automatically.

Moreover, with respect to FIG. 3 and the flow of exemplary method 300, it is understood and appreciated that identifying a given file as shown in block 304 may be expanded for a variety of options, e.g., user modifies attribute of data blocks 408 to indicate preference for Archive, block 306, or review native attributes of data blocks 408 to identify a subset for archive, block 308, or review archive path to identify data blocks 408 intended for archive, block 310. Of course, with respect to modifying attributes, from the perspective of a user, such as a human user, he or she may utilize a graphical user interface to review the name space and select files he or she desires to archive. This indication being recognized by ASDFS 200 with the result that attributes of the corresponding data blocks 408 are adjusted.

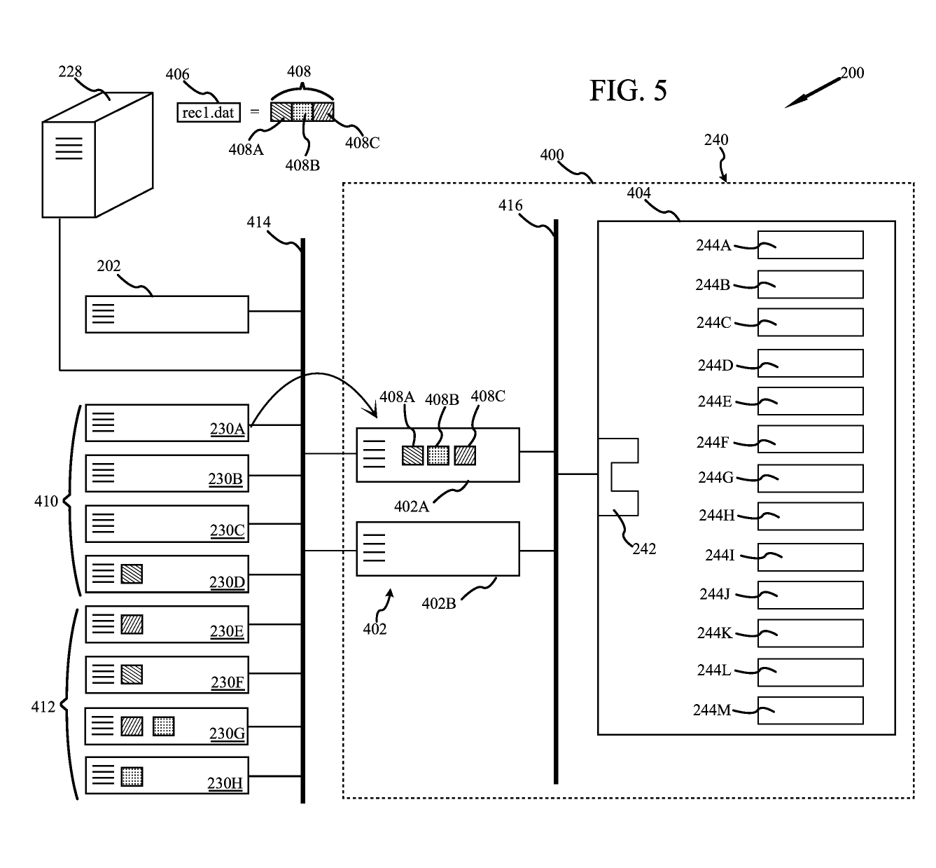

As shown in FIG. 5, method 300 continues with moving the set of data blocks 408A, 408B and 408C of the given file to the Archive Data Node 402A, block 312. As is shown in FIG. 5, the given file, e.g., first data element 406 is still represented as a set of distinct data blocks 408A, 408B and 408C now disposed to Archive Data Node system 402.

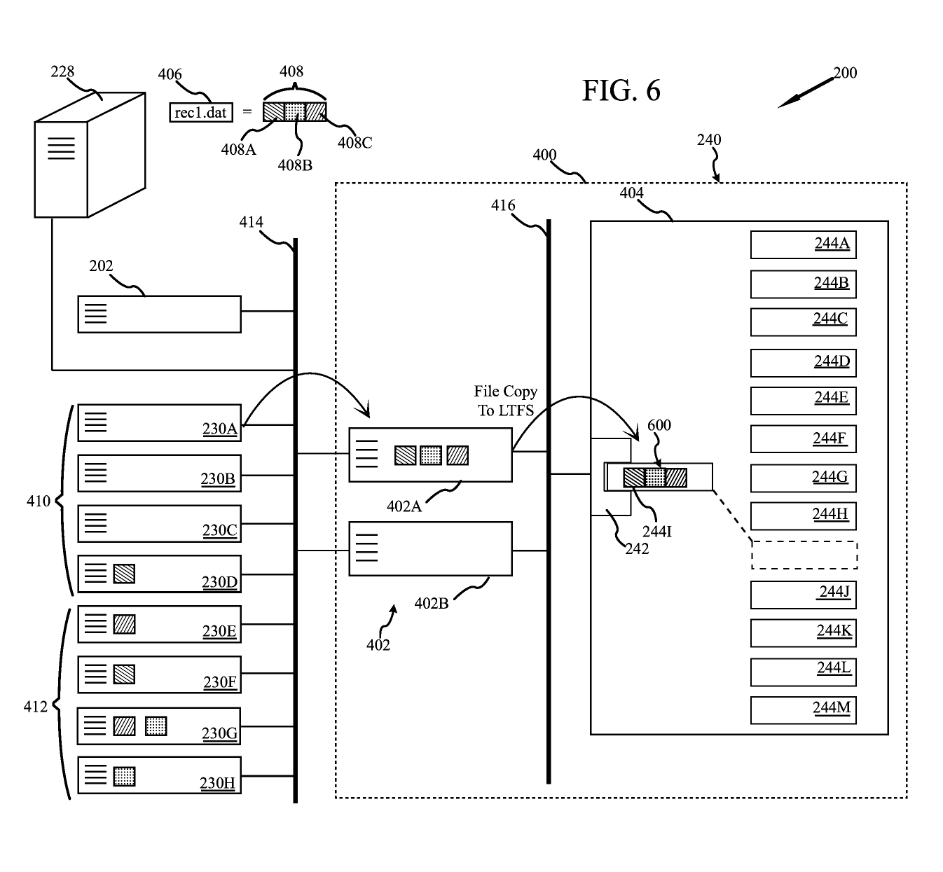

As shown in FIG. 6, a portable data storage element 244I is selected and engaged with the data read/write device 242. Method 300 now proceeds to archive the set of data blocks 408A, 408B and 408C of the given file to the portable data storage element 244I, as file 600, block 314. In at least one embodiment, the archiving process is performed in accordance with Linear Tape file System “LTFS” transfer and data structures. In varying alternative embodiments, the archiving process is performed with tar, ISO9660, or other formats appropriate for the portable data storage elements 244 in use.

As noted above, for at least one embodiment the portable storage elements 244 are non-powered portable storage elements. For this optional embodiment, method 300′ proceeds to archive the set of data blocks 408A, 408B and 408C of the given file to at least one non-powered data storage element, such that the archived data is maintained in a non-powered state, optional block 316. Further, the non-powered portable data element may be stored physically separated apart from the read/write device 242, optional block 318. In addition, at least one additional copy of the non-powered archive as maintained by a non-powered portable data storage element may be removed from ASDFS 200, such as for the purpose of disaster recovery.

The map record of the Name Node 202 is updated to identify the Archive Data Node 240 as the repository of the given file, i.e., first data element 406 now archived as archive file 600, block 320. As is illustratively shown method 300, queries to see if further archiving is desired, decision 322. Indeed, it should be understood and appreciated that for at least one embodiment, multiple instances of method 300, including the optional variations of blocks, 308, 310 and 312 may be performed substantially concurrently.

With the archive process confirmed, the data blocks 408A, 408B and 408C are expunged from the volatile memory of Archive Data Node system 402 so as to permit the Archive Data Node system 402 to commence with the processing of the next archive file, or to respond to a directive from the Name Node 202 to manipulate the data associated with at least one archived file.

Moreover, as is conceptually illustrated by the number of portable data storage elements 244A-244M with respect Archive Data Node system 402, the Archive Data Node 240 provides advantages of a vast storage capacity that is typically far greater and less costly in terms of at least size, capacity and power consumption on a byte for byte comparison than the active storage resources provided to a traditional Active Data Node 230.

As is also shown in the illustration of FIG. 6, the distinct data blocks 408A, 408B and 408C are coalesced as the archive version of the given file, i.e., file 600, during the archiving process. As such, it is understood and appreciated that the given file may be directly accessed by at least one file system other than HDFS. Moreover, for purposes of disaster recovery, the return of a client's data, historical review, implantation of a new file system or other desired task, the given file can be immediately provided without further burden upon the traditional distributed file system. Yet these possible features and capabilities are provided concurrently with the archive capability of ASDFS 200, i.e., file 600 being available in ASDFS 200 as if it were present upon an Active Data Node 230.

To summarize, for at least one embodiment, provided is a method 300 for archiving data in a distributed file system, such as ASDFS 200, having at least one Archive Data Node 240, having a data read/write device 242 and a plurality of portable data storage elements 244 compatible with the data read/write device 242. Method 300 permits a user of ASDFS 200 to identify a given file 406 for archiving, the given file 406 subdivided as a set of data blocks 408A, 408B and 408C distributed to a plurality of Active Data Nodes 230. Method 300 moves the set of data blocks 408A, 408B and 408C of the given file 406 to the Archive Data Node 240, and archives the set of data blocks 408A, 408B and 408C of the given file 406 to at least one portable data storage element 244 with the read/write device 242 as the given file 406. A map record of at least one Name Node 202 is updated to identify the Archive Data Node 240 as the repository of the set of data blocks 408A, 408B and 408C of the given file 406.

For at least one alternative embodiment, provided is method 300′ for archiving data in a distributed file system, such as ASDFS 200, having at least one Archive Data Node 240, having a data read/write device 242 and a plurality of non-powered portable data storage elements 244 compatible with the data read/write device 242. Method 300′ permits a user of ASDFS 200 to identify a given file 406 for archiving, the given file 406 subdivided as a set of data blocks 408A, 408B and 408C distributed to a plurality of Active Data Nodes 230. Method 300 moves the set of data blocks 408A, 408B and 408C of the given file 406 to the Archive Data Node 240, and archives the set of data blocks 408A, 408B and 408C of the given file 406 to at least one non-powered portable data storage element 244 with the read/write device 242 as the given file 406, device, the archive maintained in a non-powered state. A map record of at least one Name Node 202 is updated to identify the Archive Data Node 240 as the repository of the set of data blocks 408A, 408B and 408C of the given file 406.

As noted above, the Archive Data Node 240 permits ASDFS 200 to flexibly enjoy a B number of Archive copies that are mapped so as to appear as the total number N of expected copies within ASDFS 200. In varying embodiment, all of the data blocks 408A, 408B and 408C appearing to represent a given file 406 may be maintained by the Archive Data Node 240, or some number of sets of data blocks 408A, 408B and 408C may be maintained by the Active Data Nodes 230 in addition to those maintained by Archive Data Node 240. Further, in varying embodiments the number of archive copies B may be equal to N, greater than N or at least one less than N.

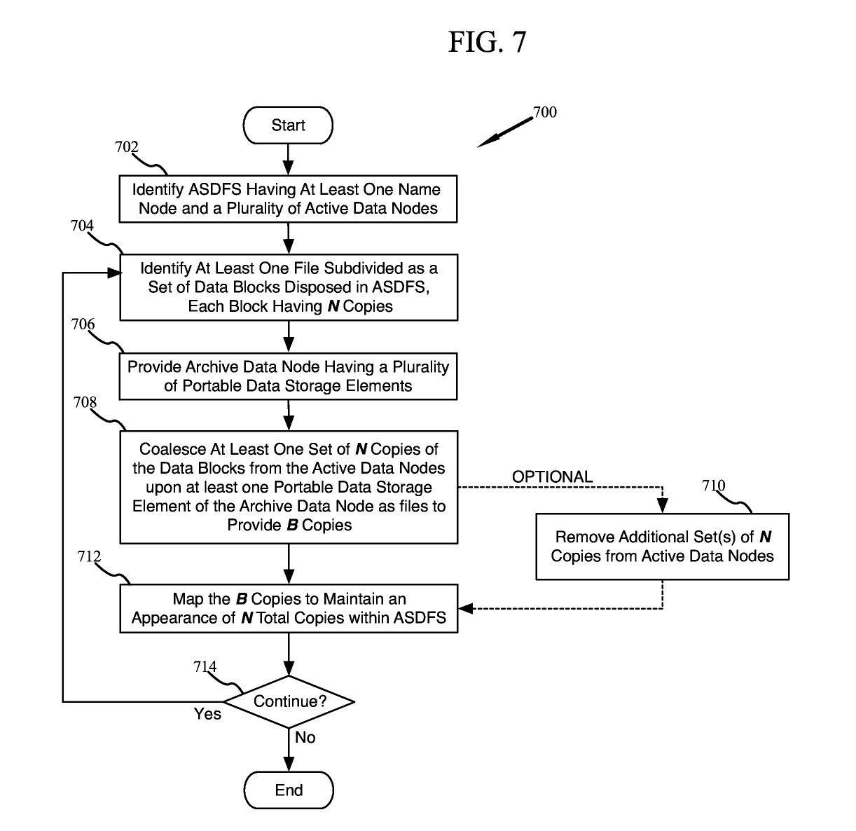

FIG. 7 provides at least one method 700 for how ASDFS 200 advantageously permits at least one embodiment to accommodate B copies within the archive mapping to N expected copies. As with method 300, described above, it will be understood and appreciated that the described method need not be performed in the order in which it is herein described, but that this description is merely exemplary of yet another method for archiving under ASDFS 200.

The method 700 commences by identifying a distributed file system, such as ASDFS 200, having at least one Name Node 202 and a plurality of Active Data Nodes 230, block 700. It is understood and appreciated that if ASDFS 200 is provided, then it is also identified, however the term “identify” has been used to clearly suggest that ASDFS 200 may be established by augmenting an existing distributed file system, such as a traditional Hadoop system.

Indeed, FIG. 4 is equally applicable for method 700 as it depicts the fundamental elements as described above. Method 700 proceeds by identifying at least one file 406 that has been subdivided as a set of data blocks 408A, 408B and 408C disposed in the distributed file system, each block having N copies, block 704. Again as shown in FIG. 4 the data blocks 408A, 408B and 408C have been distributed as three (3) copies upon Active Data Nodes 230A-230H.

As in method 300, method 700 also provides at least one Archive Data Node 230, having a plurality of data storage elements 244, block 704. In varying embodiments these data storage elements 244 may be portable data storage elements as well as non-powered data storage elements 244.

In addition, as described above with respect to method 300, the aspect of identifying a given file for archive, varying embodiments may be adapted to implement the process of identification in different ways. For example, in at least one embodiment, each data block is understood and appreciated to have at least one attribute. For at least one embodiment, this attribute is a native attribute such as the date of last use, i.e., the date of last access for read or write, that is understood and appreciated to be natively available in a traditional distributed file system. In at least one alternative embodiment, this attribute is an enhanced attribute that is provided as an enhanced user feature for users of ASDFS 200, such as additional metadata regarding the author of the data, the priority of the data, or other aspects of the data.

For at least one embodiment, the attributes of each data block are reviewed to determine at least a subset of data blocks for archive. For example, in a first instance data blocks having an attribute indicating a date of last use more than 6 months back from the current date are identified as appropriate for archive. In a second instance, data blocks having an attribute indicating that they are associated with a user having low priority are identified as appropriate for archive.

For at least one other alternative embodiment, the identifying of a given file for archive can also be achieved by using the existing name space present in the distributed file system. For example, in at least one embodiment, the name space includes at least one archive path, e.g., “/archive.”

Data elements that are placed in the archive path are understood and appreciated to be appropriate for archiving. The archiving process can be implemented at regular time intervals, such as an element of system maintenance, or at the specific request of a client 228. It should also be understood and appreciated that an attribute of each data block may also be utilized for identifying a given file for migration to the archive path. Moreover, for data blocks having a date of last use older than a specified date may be identified by at least one automated process and moved to the archive path automatically.

As shown in FIGS. 5 and 6, method 700 continues by coalescing at least one set of N copies of the data blocks 408A, 408B and 408C from the Active Data Nodes 230 upon at least one portable data storage element 244, such as 244I shown in FIG. 6, block 708. As is shown in FIG. 6, the coalescing of the data blocks blocks 408A, 408B and 408C from Active Data Nodes 230A, 230B and 230C to the Archive Data Node system 402A, and finally to portable data storage element 244I has maintained the total number of copies at three (3). Moreover, the B archive copies, which in this first case are one are simply mapped in substantially the same way as any other set of copies maintained by the Active Data Nodes 230, block 712.

It is understood and appreciated that for at least one optional embodiment, method 700 includes the optional removal of additional set(s) of N copies of data blocks 408A, 408B and 408C from the Active Data Nodes 230, optional block 710. In such embodiments, the B copies are accordingly mapped so as to maintain the appearance of N total copies within ASDFS 200, block 712. In addition, for at least one additional embodiment, portable data storage element 244I is duplicated so as to create at least one additional archive copy of data blocks 408A, 408B and 408C coalesced as archive file 600. This additional copy, not shown, may be further safeguarded such as being removed to an off site facility for disaster recovery. Moreover, in addition to being provided in a format suitable for direct mounting by another file system apart from HDFS, in the event of a catastrophic event, the offsite archive copies on additional portable data storage elements when provided to Archive Data Node 240 will permit restoration of ASDFS 200 in an expedited fashion that is likely to be faster then more traditional backup and restoration processes applied individually to each Active Data Node 230.

Method 700, then queries to see if further archiving is desired, decision 714. Indeed, it should be understood and appreciated that for at least one embodiment, multiple instances of method 700, including the optional variations of blocks, 308, 310 and 312 may be performed substantially concurrently.

To summarize, for at least one embodiment, provided is method 700 for archiving data in a distributed file system, such as ASDFS 200. Method 700 commences by identifying a distributed file system having at least one Name Node 202 and a plurality of Active Data Nodes 230 and identifying at least one file 406 subdivided as a set of blocks 408A, 408B, 408C disposed in the distributed file system, each block 408A, 408B, 408C having N copies, each copy on a distinct Active Data Node 230. Method 700 also provides at least one Archive Data Node 240 having a plurality of portable data storage elements 244. Method 700 coalesces at least one set of N copies of the data blocks 408A, 408B, 408C from the Active Data Nodes 230 upon at least one portable data storage element 244 of the Archive Data Node 240 as files 600 to provide B copies; and maps the B copies to maintain an appearance of N total copies within the distributed file system.

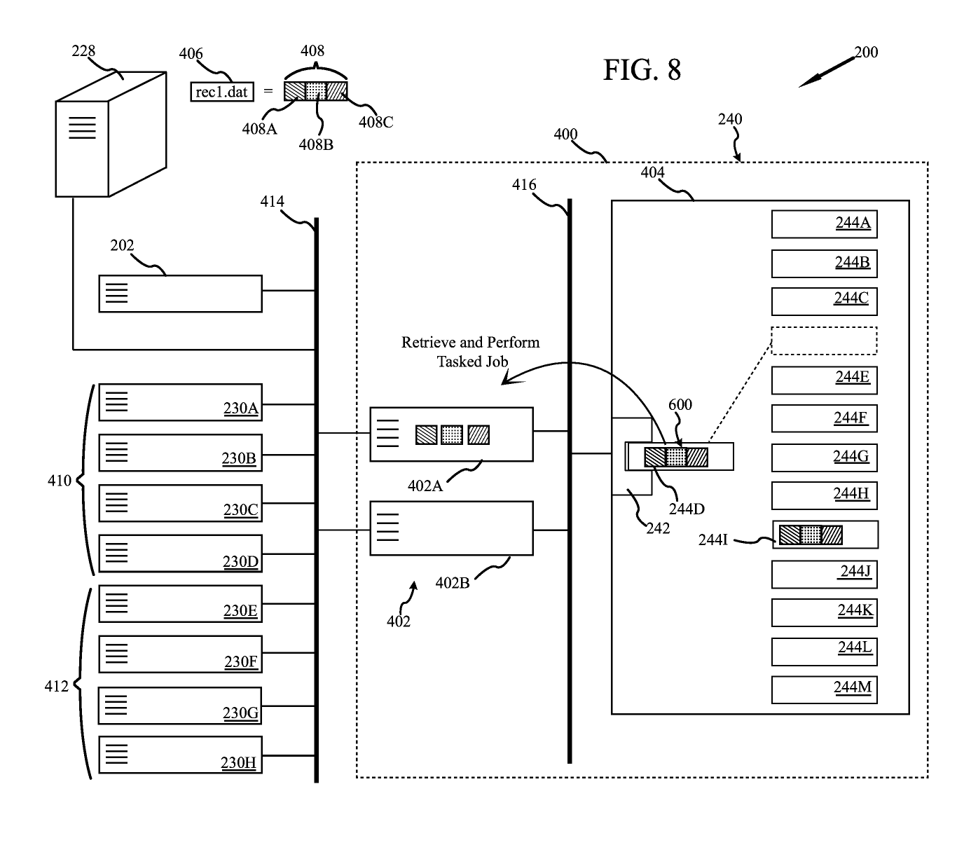

In FIG. 8, all active copies of the data blocks 408A, 408B and 408C have been expunged from the Active Data Nodes 230A-230H. Whereas originally three (3) copies were supported by the Active Data Nodes 230A-230H, now two (2) copies are illustrated, one disposed to portable data storage element 244I and a second disposed to portable data storage element 244D.

At such time as a request to manipulate the data of the given file is initiated, the data blocks 408A, 408B and 408C of the given file are retrieved from an appropriate portable data storage element 244, such as portable data storage element 244D by engaging the portable data storage element 244D with data read/write device 242, reading the identified file data, e.g. archive file 600, and transporting the relevant file data as data blocks 408A, 408B and 408C back to Archive Data Node system 402 for appropriate processing and/or manipulation of the data as requested. In varying embodiments, the mapping of the data blocks 408A, 408B and 408C to archive file 600 may be maintained by the Archive Data Node 240, and more specifically the Archive Data Node system 402A, the archive library 404, or the Archive Name Node 246 shown in FIG. 2.

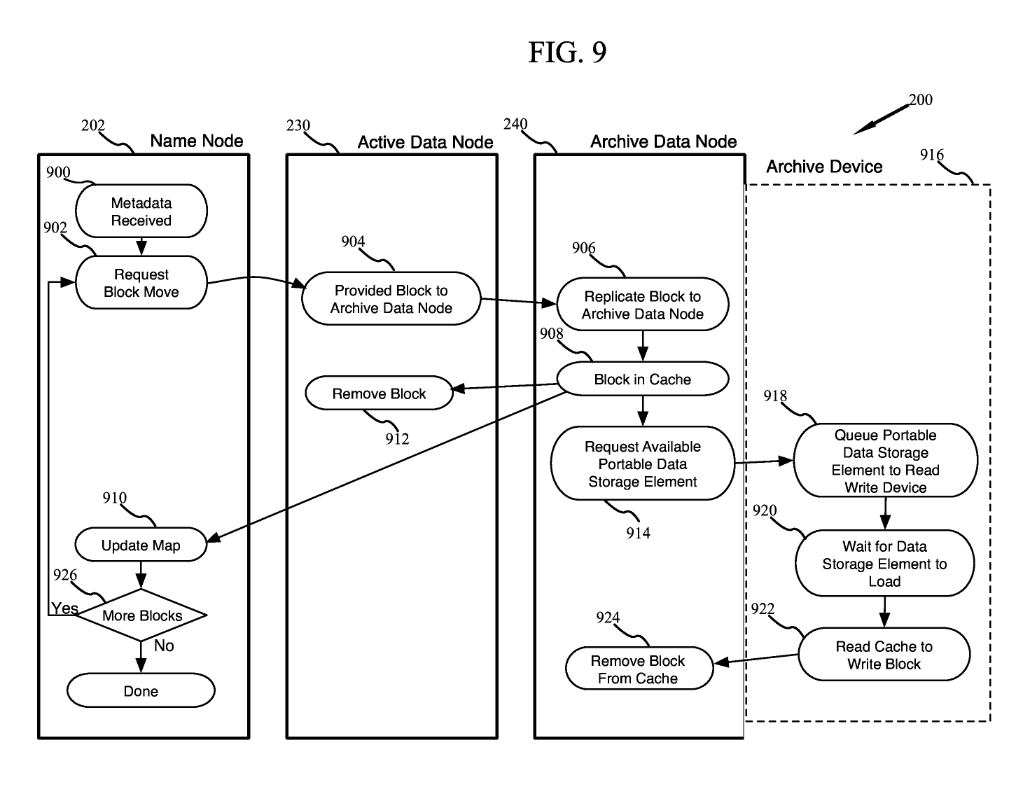

With respect to the above description, FIG. 9 is provided to conceptually illustrate yet another view of the flow of data and operation within ASDFS 200 to achieve an archive. As shown, metadata is received by a Name Node 202, action 900. This metadata is reviewed and understood as a request to move the data blocks representing a given file, action 902. A directive to initiate this migration is provided to the Active Data Node 230 Data Node 240, action 904.

For an alternative embodiment, the directive to initiate this migration may be provided to the Archive Data Node 240, which in turn will request the data blocks from the Active Data Node 230.

In response to the directive, the Active Data Node 230 provides the first data block of the given file to the Archive Data Node 240 so that the Archive Data Node 230 may replicate the first data block, action 906. When the first block is received by the Archive Data Node it is cached, or otherwise temporarily stored, action 908.

Once the Archive Data Node has the first data block, the map, e.g., map 210, is updated to indicate that the Archive Data Node 240 is now responsible, action 910. In addition, that block can be expired from the Active Data Node 230, action 912. It is understood and appreciated that the expiring of the data block can be performed at the convenience of the Active Data Node 230 as the Archive Data Node 240 is now recognized as being responsible. In other words, the Archive Data Node 240 can respond to a processing request involving the data block, should such a request be initiated during the archive process.

With the first block in cache, the Archive Data Node 240 initiates a request is for an available portable data storage element, action 914. The archive device 916, either as a component of the Archive Data Node 240, or an appliance/system associated with the Archive Data Node 240, queues the portable data storage element to the read/write device, action 918. Given the physical nature of movement of the portable data storage devices and the time to engage a portable data storage element with a read/write device, there is a period of waiting, action 920.

When the portable data storage device is properly registered by the read/write device, the block is read from the cache and written to the portable data storage device, action 922. The block is then removed from the cache, action 924.

Returning to the action of updating the map, action 910, following this or contemporaneously therewith, a query is performed to determine if additional data blocks are involved for the given file, action 926, and if so the next data block is identified and requested for move, action 902 once again. Moreover, it should be understood and appreciated that multiple blocks may be in migration from the Active Data Node 230 to the Archive Data Node 240 during the general archiving process. Again, to a requesting client or application, the Archive Data Node 240 is transparent in nature from the Active Data Nodes 230, which is to say that the Archive Data Node 240 will respond as if it were an Active Data Node 230.

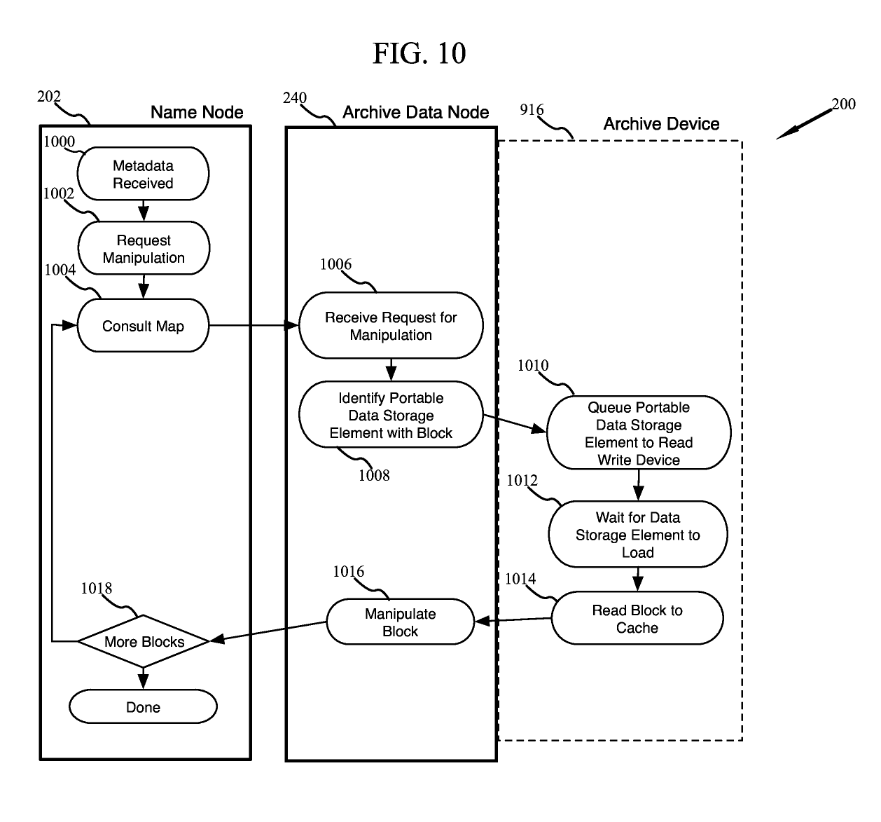

FIG. 10 is provided to conceptually illustrate yet another view of the flow of data operation within ASDFS 200 to utilize archived data in response to a directive for manipulation of that data. As shown, metadata is received by the Name Node 202, action 1000. This metadata is reviewed and understood as a request to manipulate the data blocks representing a given file, action 1002. The map is consulted and Archive Data Node 240 is identified as the repository for the block in question, action 1004.

A request to manipulate the data as specified is then received by the Archive Data Node 240, action 1006. The Archive Data Node 240 identifies the portable data storage element 244 with the requisite data element, action 1008. The archive device 812, either as a component of the Archive Data Node 240 or an appliance associated with the Archive Data Node 240, queues the portable data storage element to the read/write device, action 1010. Given the physical nature of movement of the portable data storage devices and the time to engage the portable data storage device with the read/write device, there is a period of waiting, action 1012.

When the portable data storage device is properly registered by the read/write device, the block is read from the portable data storage device and written to the cache of the Archive Data Node 220, action 1014. The data block is then manipulated in accordance with the received instructions, actions 1016. A query is performed to determine if additional data blocks are involved, action 1016, and if so the next data block is identified, action 1002 once again.

Typically in ASDFS 200 the results of data manipulation are new files, which themselves are subdivided into one or more data blocks 216 for distribution among the plurality of Active Data Nodes 230. As such, for at least one embodiment, the results of data manipulation as performed by the Archive Name Node are not by default directed back into the archive, but rather are directed out to Active Data Nodes 230 for the likely probability of further use. Of course these results may be identified for archiving by the methods described above.

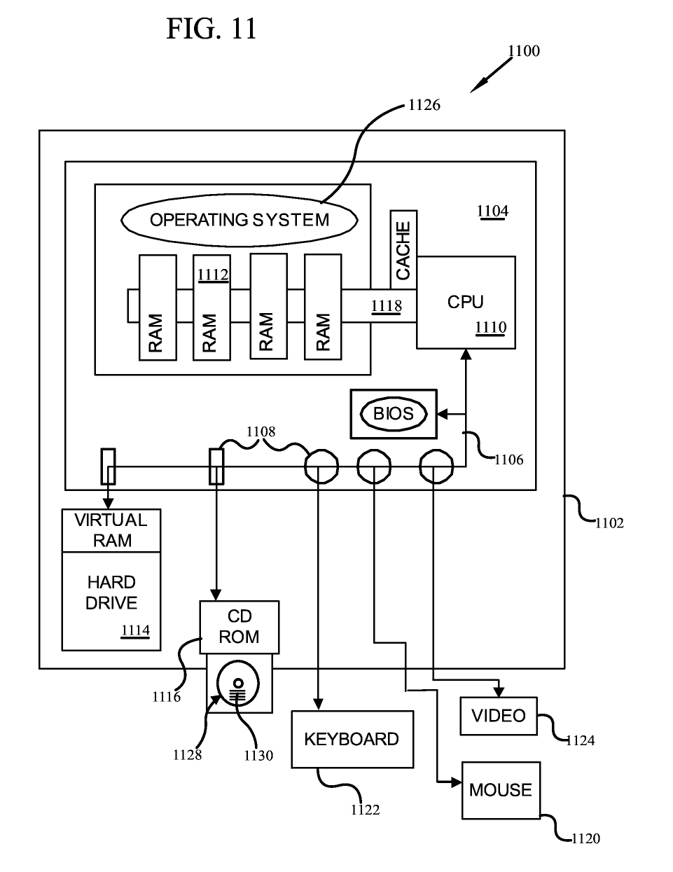

With respect to the above description of ASDFS 200 and method 300 it is understood and appreciated that the method may be rendered in a variety of different forms of code and instruction as may be used for different computer systems and environments. To expand upon the initial suggestion of a computer assisted implementation as indicated by FIG. 2, FIG. 11 is a high level block diagram of an exemplary computer system 1100 that may be incorporated as one or more elements of a Name Node 202, an Active Data Node 230, an Archive Data Node 240 or other computer related elements as discussed herein or as naturally desired for implementation of ASDFS 200 and method 300.

Computer system 1100 has a case 1102, enclosing a main board 1104. The main board 1104 has a system bus 1106, connection ports 1108, a processing unit, such as Central Processing Unit (CPU) 1110 with at least one macroprocessor (not shown) and a memory storage device, such as main memory 1112, hard drive 1114 and CD/DVD ROM drive 1116.

Memory bus 1118 couples main memory 1112 to the CPU 1110. A system bus 1106 couples the hard disc drive 1114, CD/DVD ROM drive 1116 and connection ports 1108 to the CPU 1110. Multiple input devices may be provided, such as, for example, a mouse 1120 and keyboard 1122. Multiple output devices may also be provided, such as, for example, a video monitor 1124 and a printer (not shown).

Computer system 1100 may be a commercially available system, such as a desktop workstation unit provided by IBM, Dell Computers, Apple, or other computer system provider. Computer system 1100 may also be a networked computer system, wherein memory storage components such as hard drive 1114, additional CPUs 1110 and output devices such as printers are provided by physically separate computer systems commonly connected together in the network. Those skilled in the art will understand and appreciate that the physical composition of components and component interconnections are comprised by the computer system 1100, and select a computer system 1100 suitable for the establishing a Name Node 202, an Active Data Node 230, and or an Archive Data Node 240.

When computer system 1100 is activated, preferably an operating system 1126 will load into main memory 1112 as part of the boot strap startup sequence and ready the computer system 1100 for operation. At the simplest level, and in the most general sense, the tasks of an operating system fall into specific categories, such as, process management, device management (including application and user interface management) and memory management, for example.

In such a computer system 1100, and with specific reference to a Name Node 202, an Active Data Node 230, and or the Archive Data Node 240, for each system each CPU is operable to perform one or more of the methods or portions of the methods as associated with each device for establishing ASDFS 200 as described above. The form of the computer-readable medium 1128 and language of the program 1130 are understood to be appropriate for and functionally cooperate with the computer system 1100. In at least one embodiment, the computer system 1100 comprising at least a portion of the Archive Data Node 240 is a SpectraLogic nTier 700, manufactured by Spectra Logic Corp., of Boulder Colo.

It is to be understood that changes may be made in the above methods, systems and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, system and structure, which, as a matter of language, might be said to fall therebetween.

What is claimed is:

1. An archive system for a distributed file system, comprising:
a distributed file system having at least one Name Node and a plurality of Active Data Nodes, a first data element disposed in the distributed file system as a plurality of data blocks, each data block having N copies, each copy on a distinct Active Data Node and mapped by the Name Node;
at least one Archive Data Node having a data read/write device and a plurality of portable data storage elements compatible with the data read/write device, the Archive Data Node structured and arranged to receive the first data element data blocks from the Active Data Nodes and archive the received data blocks upon at least one portable data storage element, the number of archive copies for each data block being a positive number B.

2. The system of claim 1, wherein B is at least one less than N.

3. The system of claim 1, wherein B is equal to N.

4. The system of claim 1, wherein B is greater than N.

5. The system of claim 1, wherein the archive system is structured and arranged such that the B copies are mapped to replace from 1 to N copies of the data blocks on the Active Data Nodes.

6. The system of claim 1, wherein the distributed file system is a Hadoop Distributed File System (HDFS).

7. The system of claim 1, further including an Archive Name Node disposed between the Name Node and the Archive Node, the Archive Name Node structured and arranged to map the archived data blocks of the first data element and any un-archived instances of data blocks of the first data element.

8. The system of claim 1, wherein to a user or requesting application, the at least one Archive Data Node is transparent in nature from the at least one active data node.

9. A method for archiving data in a distributed file system, comprising:
identifying a Hadoop style distributed file system having at least one Name Node and a plurality of Active Data Nodes;
identifying at least one file subdivided as a set of blocks disposed in the distributed file system, each block having N copies, each copy on a distinct Active Data Node;
providing at least one Archive Data Node having a plurality of portable data storage elements;
coalescing at least one set of N copies of the data blocks from the Active Data Nodes upon at least one portable data storage element of the Archive Data Node as files to provide B copies; and
mapping the B copies to maintain an appearance of N total copies within the distributed file system.

10. The method of claim 9, wherein in a first instance B is at least one less than N, in a second instance B is equal to N, and in a third instance B is greater than N

11. The method of claim 9, wherein from 1 to N copies of the data blocks on the Active Data Nodes are removed.

12. The method of claim 9, wherein the archive copy is established as a coalesced file from the first set of data blocks.

13. The method of claim 9, wherein identifying the given file for archiving is achieved by a comparing the data of last use for each set of blocks to a predefined date.

14. The method of claim 9, wherein to a user or a requesting application, the at least one Archive Data Node is transparent in nature from the at least one active data node.

15. The method of claim 9, further including providing an Archive Name Node disposed between the Name Node and the Archive Data Node, the Archive Name Node structured and arranged to manage a map record identifying the Archive Data Node as the repository of the at least one copy of the at least one identified file.

16. A method for archiving data in a distributed file system, comprising:
identifying a distributed file system having at least one Name Node and a plurality of Active Data Nodes;
providing at least one Archive Data Node having a data read/write device and a plurality of portable data storage elements compatible with the data read/write device;
permitting a user of the distributed file system to identify a given file for archiving, the given file subdivided as a set of data blocks disposed in the distributed file system, each data block having N copies, each copy on a distinct Active Data Node;
migrating a first set of blocks of the given file from an Active Data Node to the Archive Data Node;
archiving the first set of blocks to at least one portable data storage element with the read/write device to provide at least B number of Archive copies;
deleting at least the first set of blocks from the Active Data Node; and
updating a map record of at least one Name Node to identify the Archive Data Node as the repository of at least one copy of the given file.

17. The method of claim 16, wherein in a first instance B is at least one less than N, in a second instance B is equal to N, and in a third instance B is greater than N.

18. The method of claim 16, wherein the distributed file system is a Hadoop Distributed File System (HDFS).

19. The method of claim 16, wherein the archived copy of the given file is mapped to represent from one to N copies of the given file.

20. The method of claim 16, wherein migrating the data blocks is performed with the Hadoop file system move command.

21. The method of claim 16, wherein in a first instance the user is a human user, and in a second instance the user is an application.

22. The method of claim 16, including providing an Archive Name Node disposed between the Name Node and the Archive Data Node, the Archive Name Node structured and arranged to manage the map record identifying the Archive Data Node as the repository of the at least one copy of the given file.
